(19) United States
(12) Patent Application Publication
(10) Pub. No.: US 2006/0263575 A1
(43) Pub. Date: Nov. 23, 2006

(54) Method of rigidifying a foam panel and a foam panel

(76) Inventor: Gordon Ritchie, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/437,597

(22) Filed: May 18, 2006

(30) Foreign Application Priority Data
May 18, 2005 (CA) 2,510,279

(51) Int. Cl. B32B 3/00; B32B 7/00

(52) U.S. Cl. 428/119; 428/71

(57) ABSTRACT

A foam panel and method of reinforcing the same, includes a first sheet and a second sheet in parallel spaced relation defining a sandwich cavity between the first sheet and the second sheet. Reinforcing strips of sheeting material are positioned on edge transversely across the sandwich cavity, with one edge engaging the first sheet and an opposed edge engaging the second sheet. Foam insulation fills the remainder of the sandwich cavity.

### FIELD OF THE INVENTION

The present invention relates to a method of rigidifying a foam panel and a foam panel that has been made more rigid by application of the method.

### BACKGROUND OF THE INVENTION

There are some environments in which it is highly desirable for a foam panel to have increased rigidity. One example is when the foam panel is used to construct a building in a geographic region that is periodically subjected to hurricane force winds. Another example is when the foam panel is intended for use as flooring.

U.S. Pat. No. 5,519,971 (Ramirez 1996) discloses a sandwich panel having a foam core. Spacer blocks are positioned between the panel members to improve the rigidity of the panel.

### SUMMARY OF THE INVENTION

According to one aspect of the present invention there is provided a method of rigidifying a foam panel. A first step involves positioning a first sheet and a second sheet in parallel spaced relation defining a sandwich cavity between the first sheet and the second sheet. A second step involves positioning reinforcing strips of sheeting material on edge transversely across the sandwich cavity with one edge engaging the first sheet and an opposed edge engaging the second sheet. A third step involves filling a remainder of the sandwich cavity with foam insulation.

According to another aspect of the present invention there is provided a foam panel, which includes a first sheet and a second sheet in parallel spaced relation defining a sandwich cavity between the first sheet and the second sheet. Reinforcing strips of sheeting material are positioned on edge transversely across the sandwich cavity, with one edge engaging the first sheet and an opposed edge engaging the second sheet. Foam insulation fills a remainder of the sandwich cavity.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a top plan view, in section, of a foam panel constructed in accordance with the teaching of the present method.

FIG. 2 is a front elevation view, in section, of the foam panel illustrated in FIG. 1.

FIG. 3 is a front elevation view, in section, of an alternative of the foam panel illustrated in FIG. 1.

### DETAILED DESCRIPTION OF THE PREFERRED EMBODIMENT

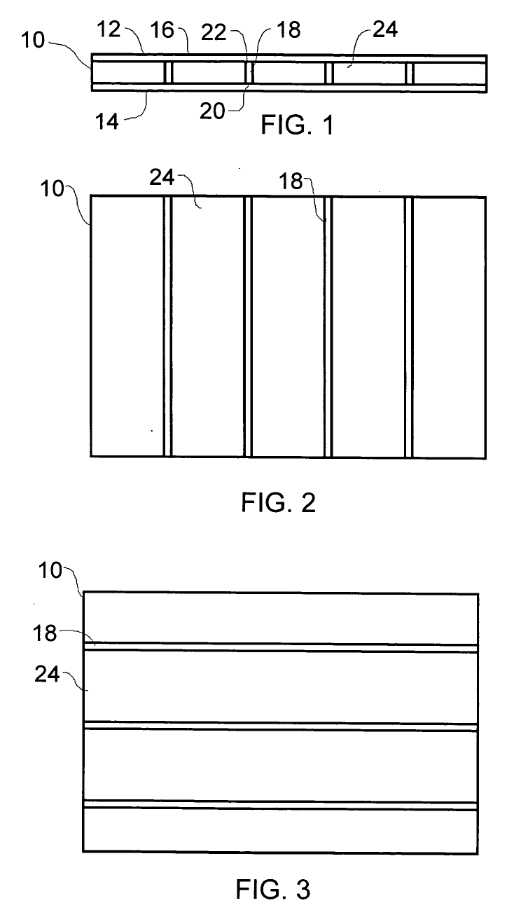

The preferred embodiment, a foam panel generally identified by reference numeral 10, will now be described with reference to FIGS. 1 through 3.

Structure and Relationship of Parts:

Referring now to FIG. 1, there is shown foam panel 10, including a first sheet 12 and a second sheet 14 in parallel spaced relation defining a sandwich cavity 16 between first sheet 12 and second sheet 14. Reinforcing strips 18 of sheeting material on edge transversely across sandwich cavity 16 with one edge 20 engaging first sheet 12 and an opposed edge 22 engaging second sheet 14. Referring to FIG. 2, reinforcing strips are shown spaced throughout foam panel 10, and extend the height of panel 10. Reinforcing strips 18 are shown to extend in parallel spaced relation for substantially the entire width of sandwich cavity 16. Referring to FIG. 3, reinforcing strips 18 may also extend substantially the entire length of sandwich cavity 16. Reinforcing strips 18 as shown are made from the same sheet material as first sheet 12 and second sheet 14, only cut into strips. Foam insulation 24 such as non-combustible foam glass is used to fill sandwich cavity 16. First sheet 12, second sheet 14, and reinforcing strips 18 are made from non-combustible material such as magnesium oxide, calcium silicate or cement.

Operation:

The use of foam panel 10 will now be discussed with reference to FIGS. 1 through 3. Referring to FIG. 1, foam panel 10 is prepared with reinforcing strips 18 inserted between first sheet 12 and second sheet 14. Referring to FIG. 2, foam panel 10 is then able to be used either as a wall piece or a floor piece in a properly constructed structure with adequate reinforcement.

Variations:

The foam panel described above represents the preferred embodiment. It will be apparent to one skilled in the art that the reinforcing strips need not extend for the entire length or width of the sandwich cavity. It will also be apparent to one skilled in the art that the reinforcing strips need not be in parallel spaced relation. This version is preferred, merely because it provides what is believed to be the best support. It is not possible to illustrate all possible variations. One variation is that the reinforcing strips could be in parallel spaced relation, but extend in a diagonal orientation. Another variation is that the reinforcing strips could be positioned randomly or in a non-parallel pattern, but be sufficient in number and sufficiently spaced to provide the desired rigidity.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

1. A method of rigidifying a foam panel, comprising:
positioning a first sheet and a second sheet in parallel spaced relation defining a sandwich cavity between the first sheet and the second sheet;
positioning reinforcing strips of sheeting material on edge transversely across the sandwich cavity with one edge engaging the first sheet and an opposed edge engaging the second sheet; and
filling a remainder of the sandwich cavity with foam insulation.

2. A foam panel comprising:
a first sheet and a second sheet in parallel spaced relation defining a sandwich cavity between the first sheet and the second sheet;
reinforcing strips of sheeting material positioned on edge transversely across the sandwich cavity with one edge engaging the first sheet and an opposed edge engaging the second sheet; and
foam insulation filling the sandwich cavity.

3. The foam panel as defined in claim 2, wherein the reinforcing strips extend for one of substantially the entire length or substantially the entire width of the sandwich cavity.

4. The foam panel as defined in claim 2, wherein the reinforcing strips are arranged in parallel spaced relation.

5. The foam panel as defined in claim 2, wherein the first sheet, the second sheet, and the reinforcing strips are made from non-combustible material.

6. The foam panel as defined in claim 5, wherein the non-combustible material is one of magnesium oxide, calcium silicate or cement.

7. The foam panel as defined in claim 2, wherein the foam insulation is non-combustible foam glass.

8. A foam panel comprising:
a first sheet and a second sheet in parallel spaced relation defining a sandwich cavity between the first sheet and the second sheet;
reinforcing strips of sheeting material on edge transversely across the sandwich cavity with one edge engaging the first sheet and an opposed edge engaging the second sheet, the reinforcing strips extending in parallel spaced relation for one of substantially the entire length or substantially the entire width of the sandwich cavity; and
foam insulation filling the sandwich cavity.

9. The foam panel as defined in claim 8, wherein the first sheet, the second sheet, and the reinforcing strips are made from non-combustible material.

10. The foam panel as defined in claim 9, wherein the non-combustible material is one of magnesium oxide, calcium silicate or cement.

11. The foam panel as defined in claim 8, wherein the foam insulation is non-combustible foam glass.
